(19) United States
(12) Patent Application Publication
(10) Pub. No.: US 2026/0294175 A1
(43) Pub. Date: Oct. 1, 2026

(54) SANDWICH CRIMPER

(71) Applicant: Crimpit Group Ltd., London (GB)

(72) Inventors: Michael Harper, London (GB); Ian Critchlow, London (GB)

(21) Appl. No.: 19/489,059

(22) PCT Filed: May 30, 2024
(86) PCT No.: PCT/GB2024/051384

§ 371 Date: Dec. 1, 2025

(30) Foreign Application Priority Data
Jun. 1, 2023 (GB) GB 2308203.5

(51) Int. Cl. A47J 43/20; A21C 9/06

(52) U.S. Cl. CPC A47J 43/20; A21C 9/068

(57) ABSTRACT

A crimper base is generally indicated at 10. The crimper base 10 has a flat lower surface 12. The crimper base 10 has a semi-circular shape having two upstanding retaining side walls 14, 16 extending perpendicularly to the plane of flat lower surface 12. A complementarily shaped crimper lid is provided and hingedly connected to the crimper base.

The present invention relates to a sandwich crimper and particularly but not exclusively to a sandwich crimper for making a crimped sandwich from a flat bread, for example a tortilla, pita bread or other wrap containing food ingredients.

### BACKGROUND TO THE INVENTION

Sealed sandwiches are made by using a single piece of folded bread, such as a tortilla or other wrap, or hollowed bread, such as a pita, with fillings contained inside the bread.

For example, tortilla sandwiches are made of thin, circular unleavened bread which is folded to include various other food ingredients and are popular worldwide. Typically, tortilla sandwiches are made by placing food ingredients at a suitable location on an unfolded tortilla and folding the tortilla in a desired configuration to enclose the food ingredients within the bread. However, forming the pocket sandwich by hand can be problematic and is certainly difficult to reproduce consistently.

There have, as a consequence, been numerous attempts to try to overcome the problems and consistently produce pocket sandwiches, especially using tortilla bread. Known pocket sandwich makers are not compact and can often be extremely complex involving complex moving parts subject to mechanical failure over time and requiring servicing, for example US2019/0053503.

It would be advantageous to reduce or substantially obviate one or more of the aforementioned problems.

### STATEMENT OF INVENTION

According to the first aspect of the invention there is provided a sandwich crimper for producing a sealed folded sandwich comprising:
a housing having two clam shell members, hingedly connected to one another and moveable between an open configuration and a closed configuration wherein the clam shell members are shaped to receive a tortilla therebetween, and wherein the clam shell members have peripheral crimping teeth to seal the edge of the tortilla when the clam shell is closed and the tortilla folded in half.

The clam shell members comprise a first shell member comprising a crimper base with a substantially flat lower surface; and a second shell member comprising a crimper lid with a substantially flat upper surface; a bottom set of peripheral crimping teeth disposed along the outer edge of the crimper base; top set of peripheral crimping teeth disposed along the outer edge of the crimper lid; teeth in each set of crimping teeth that are formed from protruding trapezoidal prisms and in which the top and bottom sets of crimping teeth are complementary to each other along every edge of the crimper base and crimper lid; and a peripheral retaining wall disposed along the outer edge of the bottom set of crimper teeth for aligning the tortilla relative to the crimping teeth and restraining the folded tortilla during the crimping process.

The sealed tortilla may possess a top and bottom face which is substantially flat, allowing the sealed tortilla to be heated without the formation of hot spots. By preventing hotspots, the entirety of each face of the folded tortilla is more likely to cook at a uniform rate. This ensures the uniform heating of the ingredients inside and reduces the chance that the outer tortilla will burn.

The trapezoidal shape of the teeth has been found to provide a stronger crimp than wave-shaped teeth, reducing the risk of the crimp coming adrift. Additionally, heat is not required to produce a strong seal.

The complementary crimping teeth may feature a continuous gap of 1-2 mm, preferably 1-1.5 mm, between each set of crimping teeth when fully engaged. This continuous gap ensures there is no tearing of the bread during the crimping process, allowing for the production of a sealed folded tortilla which is undamaged.

The crimper base may feature a base wall disposed below the bottom set of crimping teeth protruding into the centre of the crimper base from the outer edge. This allows the contents of the folded tortilla to be contained away from the crimping edge during crimping. The base wall may feature a slope to channel the contents away from the crimping teeth during crimping.

The crimping teeth may protrude from the lower surface of the crimper base or the base wall by 5 -15 mm. The base of each tooth may have a width of 5-20 mm and the opposite, parallel side may have a width of 5-20 mm.

Each clam shell member may be semi-circular and when in the open configuration form a circular housing. The crimper may have a diameter of 10-25 cm, preferably a diameter of 15-20 cm. The crimper may be preferably shaped to form a sealed folded sandwich substantially semi-circular in shape.

The crimper may have rounded corners to produce a sealed folded tortilla with rounded corners, preventing the formation of pointed corners with weaker seals.

The top and bottom sets of crimping teeth may be complementary in shape in a plurality of orientations so that there is no need for alignment pointers.

According to the second aspect of the invention there is provided a method for sealing a tortilla comprising the steps:
(a) providing a tortilla crimper according to the first aspect of the invention;
(b) inserting a tortilla into the opened clam shell such that it overlies the crimper base and lid, and is retained within the retaining wall;
(c) placing other food contents onto the tortilla disposed on the crimper base and lid;
(d) closing the crimper lid and/or crimper base, such that the tortilla is folded and the edges of the tortilla are aligned;
(e) applying pressure to the crimper lid and/or base, engaging the top and bottom sets of crimping teeth and crimping the edges of the folded tortilla.

The folded tortilla contents may include one or more of cheese, meat, fish, fruit, vegetables, spreads, and sauces or any combination thereof.

Using the tortilla crimper with this method does not require heat to produce a strong seal. Once the folded tortilla has been sealed, it may be eaten cold or heated in a pan, under a grill or in an oven or air fryer.

### BRIEF DESCRIPTION OF THE DRAWINGS

The present invention will now be described by way of example only and with reference to the accompanying drawings, in which:

FIG. 1 shows a perspective view of an embodiment of the crimper base according to the invention;

FIG. 2 shows a perspective view of a first crimper lid, which fits to the crimper base of FIG. 1.

FIG. 3 shows a perspective view of the assembled crimper in an open configuration in accordance with the present invention;

FIG. 4 shows the crimper of FIG. 3 in an intermediary position between the open and closed configuration;

FIG. 5 shows a perspective view of the assembled crimper in a closed configuration in accordance with the present invention;

FIG. 6 shows a side elevation of the crimper of FIG. 5;

FIG. 7 shows an embodiment of the present invention possessing a set of diametrically extending teeth formed from a set of upper and lower teeth each carried on a linear track;

FIG. 8 shows an upper set of teeth from FIG. 7 in accordance with the present invention;

FIG. 9 shows a lower set of teeth from FIG. 7 in accordance with the present invention; and

FIG. 10 shows the crimper base from the embodiment shown in FIG. 7.

### DESCRIPTION OF PREFERRED EMBODIMENTS

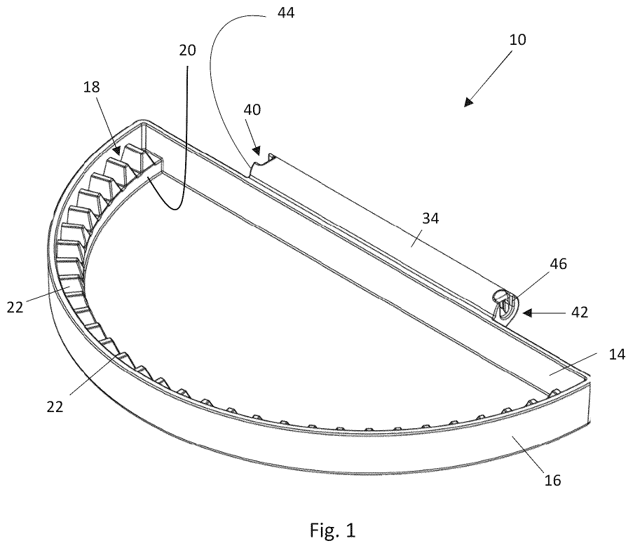

Referring firstly to FIG. 1, a crimper base 10 is a semi-circular. The crimper base 10 has a flat lower surface 12. The crimper base 10 has a semi-circular shape having two upstanding retaining side walls 14, 16 extending perpendicularly to the plane of flat lower surface 12.

In this embodiment, the size and shape of the sandwich crimper is tailored for sandwiches made from tortilla bread. However, the sandwich crimper can also be used with other breads.

Side wall 14 is an elongate straight side wall extending along the diameter of the semi-circular body of the crimper base 10. Extending along the inside edge of the curved side of the semi-circular body is a bottom set of peripheral crimping teeth 18. The bottom set of peripheral crimping teeth 18 protrude from a base wall 20. The base wall 20 is raised from the flat lower surface 12. The bottom set of peripheral crimping teeth 18 consists of a plurality of identical lower crimping teeth 22. In this embodiment, the bottom set of crimping teeth 18, protrude from the base wall 20 by 5-10 mm. Each lower crimping tooth 22 has a base width of 8-12 mm and a thickness of 5-10 mm.

The retaining side walls have a thickness of 0.3 to 0.5 cm and assists in aligning the tortilla bread relative to the bottom set of crimping teeth 14a and restrains the movement of the bread during crimping.

The base wall 20 has a height and thickness of 1-1.2 cm at its base. The base wall 20 has a thickness of 0.9-1.1 cm at the point at which the bottom set of crimping teeth 18 protrude.

The base wall 16 contains the contents of the sandwich wherein the sloped walls channel the contents of the sandwich away from the crimping edge.

Extending along the outer face of the straight side 14 of the crimper base 10 is a first hinge member 30 of hinge 32, comprising an elongate cylindrical body 34 having a longitudinally extending bore at either end 40, 42 and side wall cut outs 44, 46 each disposed either end of the cylindrical body 34.

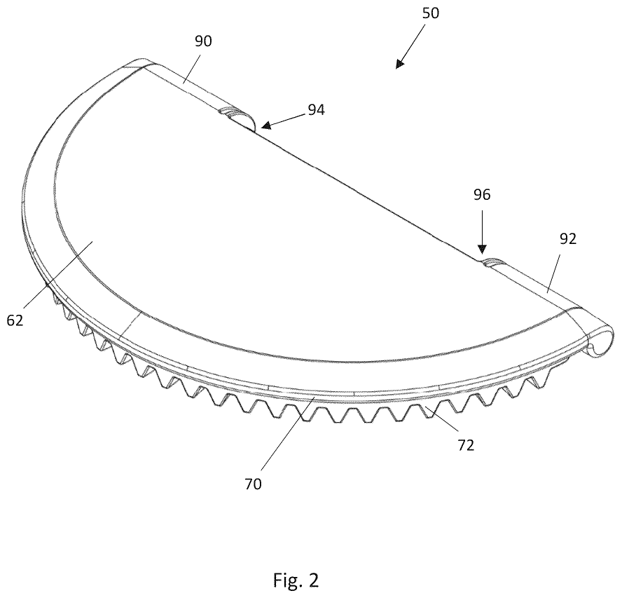

FIG. 2 shows a crimper lid 50. The crimper lid 50 is complementarily shaped with respect to the crimper base 10. The crimper lid 50 has a flat inner surface 60. The crimper lid 50 has a semi-circular shape.

Extending perpendicularly to the plane of the flat inner surface 60 along the edge of the curved side 70 of the semi-circular body 62 is a top set of peripheral crimping teeth 72. The top set of peripheral crimping teeth 72 protrude from a curved upper wall 74. The upper wall 74 is raised from the flat inner surface 60. The top set of peripheral crimping teeth 72 consist of a plurality of identical upper crimping teeth 76. In this embodiment, the top set of crimping teeth 72, protrude from the upper wall 74 by 5-10 mm. Each upper crimping tooth 76 has a base width of 5-10 mm and a thickness of 5-10 mm.

Disposed at either end of the straight edge of the crimper lid are second hinge members 60, 62 of comprising two lugs/knuckles each having a cylindrical pin 64, 66 that is complementarily shaped to and received by the recessed bores 40, 42 respectively.

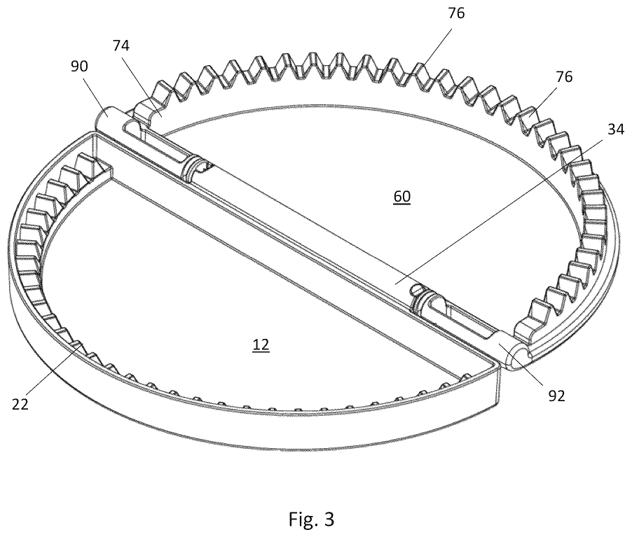

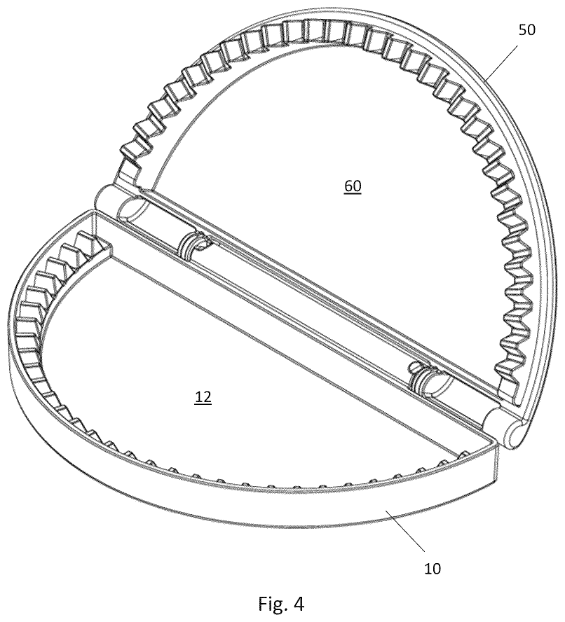

FIGS. 3 and 4 show the assembled crimper in accordance with the present invention in an open configuration. The crimper lid 50 is moveably mounted on the crimper base 10 via a hinge consisting of hinge members 90, 92 and 30. Pins 94, 96 are received in bores 40, 42 respectively and allow the crimper lid 50 to move from an open configuration in which a bread item can be placed in the crimper and a closed configuration wherein the lid 50 is closed and the upper and lower

The sandwich crimper is used to seal a tortilla folded in half and containing other food items.

The crimper is opened and a tortilla is positioned within the retaining walls. The edge of the circular tortilla is positioned above the bottom set of crimping teeth 14a. The sandwich contents are inserted on top of the tortilla, avoiding the edge.

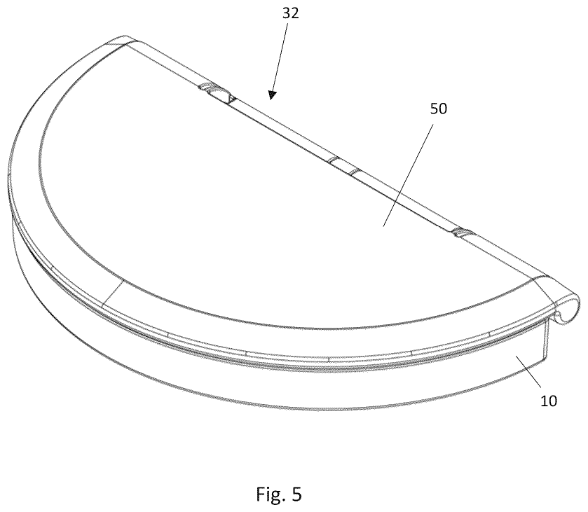

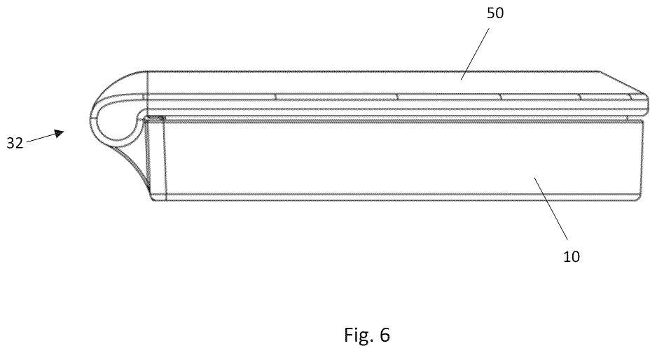

The crimper lid is rotated about the hinge to adopt the closed configuration (FIGS. 5 and 6) whereby the circular tortilla is folded in half to form a semi-circular sandwich whose open side corresponds with the curved edge. The top set of crimping teeth is aligned with the bottom set of crimping teeth. Pressure is applied to the crimper lid to engage the crimping teeth and crimp the curved edge of the sandwich. The flat lower surface and flat upper surface produce a crimped sandwich with a substantially flat top and bottom face.

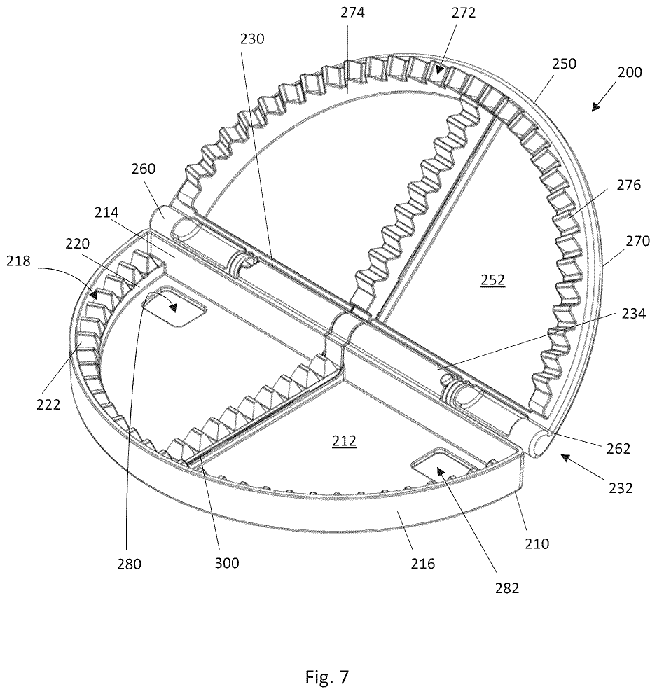

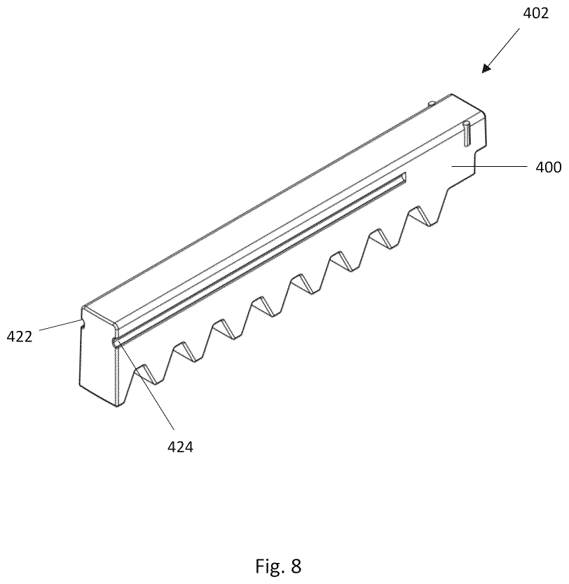

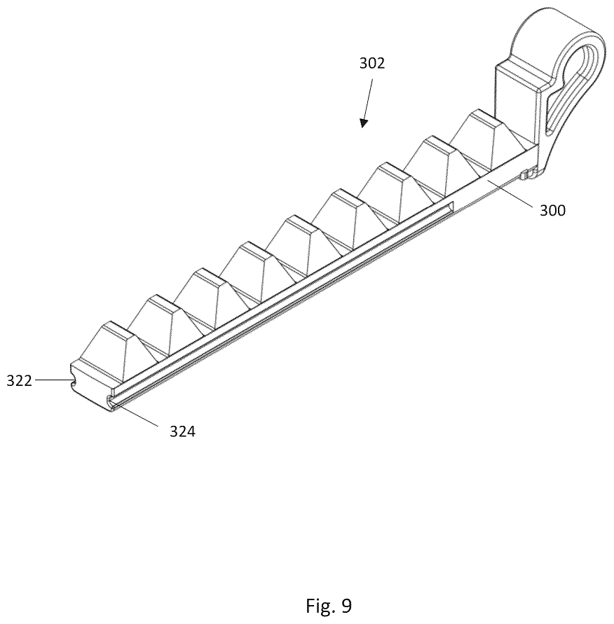

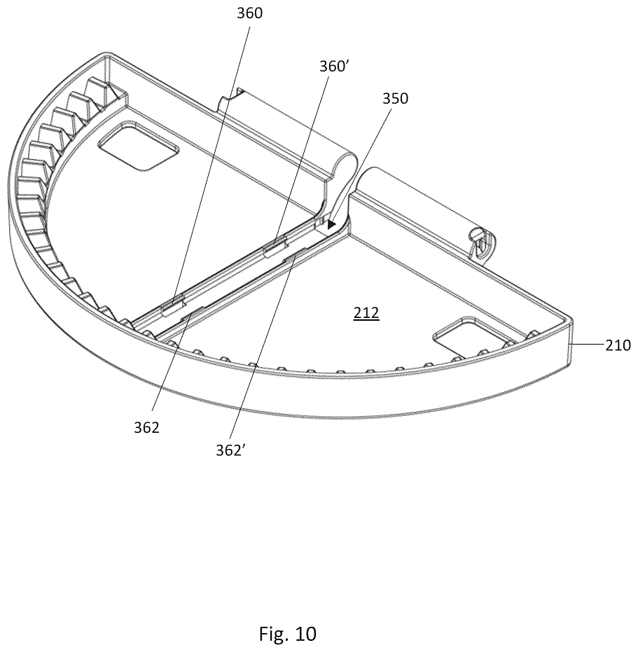

FIGS. 7 to 10 show an embodiment having a crimper base 210 with a semi-circular body. The crimper base 210 has a flat lower surface 212. The crimper base 210 has a semi-circular shape having two upstanding retaining side walls 214, 216 extending perpendicularly to the plane of flat lower surface 212.

In this embodiment, the size and shape of the sandwich crimper is tailored for sandwiches made from tortilla bread. However, the sandwich crimper can also be used with other breads.

Side wall 214 is an elongate straight side wall extending along the diameter of the semi-circular body of the crimper base 210. Extending along the inside edge of the curved side of the semi-circular body is a bottom set of peripheral crimping teeth 218. The bottom set of peripheral crimping teeth 218 protrude from a base wall 220. The base wall 220 is raised from the flat lower surface 212. The bottom set of peripheral crimping teeth 218 consists of a plurality of identical lower crimping teeth 222. In this embodiment, the bottom set of crimping teeth 218, protrude from the base wall 220 by 5-10 mm. Each lower crimping tooth 222 has a base width of 5-10 mm and a thickness of 5-10 mm.

The retaining side walls have a thickness of 0.3-0.5 cm and assists in aligning the tortilla bread relative to the bottom set of crimping teeth and restrains the movement of the bread during crimping.

The base wall 220 has a height and thickness of 1-1.2 cm at its base. The base wall 220 has a thickness of 0.9-1.1 cm at the point at which the bottom set of crimping teeth 218 protrude. The variation in thickness from the top of the base wall 220 to the bottom of the base wall 220 is achieved through a slope in the base wall 220. The base wall 216 contains the contents of the sandwich wherein the sloped walls channel the contents of the sandwich away from the crimping edge.

Extending along the outer face of the straight side 214 of the crimper base 210 is a first hinge member 230 of hinge 232, hinge member 230 consisting of a cylindrical body 234.

Crimper lid 250 is complementarily shaped with respect to the crimper base 210 having a flat inner surface 252. The crimper lid 250 has a semi-circular body.

Extending perpendicularly to the plane of the flat inner surface 252 along the edge of the curved side 270 of the semi-circular body is a top set of peripheral crimping teeth 272. The top set of peripheral crimping teeth 272 protrude from a curved upper wall 274. The upper wall 274 is raised from the flat inner surface 252. The top set of peripheral crimping teeth 272 consist of a plurality of identical upper crimping teeth 276. In this embodiment, the top set of crimping teeth 272, protrude from the upper wall 274 by 8-12 mm. Each upper crimping tooth 276 has a base width of 8-12 mm and a thickness of 8-12 mm.

The upper wall 274 has a thickness of 0.9-1.1 cm at the point at which the bottom set of crimping teeth 276 protrude.

Disposed at either end of the straight edge of the crimper lid are second hinge members 260, 262 of comprising two lugs/knuckles each having a cylindrical pin 264, 266 that is complementarily shaped to and received by the first hinge member.

Disposed in the surface 212 are two apertures 280, 292 which facilitate the removal of a sandwich once crimped.

Dissecting the semi-circular flat lower surface 212 is a bottom set of removeable teeth 302 extending radially and disposed on a linear track 300, similarly dissecting the flat upper surface 252 is an upper set of removeable teeth 402 extending radially and disposed on a linear track 400. Extending substantially along either side of the track 300 and 400 are elongate channels 322, 324 and 422, 424 respectively.

The crimper base and lid have a radially extending slots 350 and 450 respectively having two sets of tongues 360, 360′, 362, 362′ and 460, 460′, 462, 462′ respectively, either side of each slot complementarily shaped with respect to the elongate channels 322, 324 and 422, 424.

In use the removeable teeth can be inserted into the crimper base and lid and retained in the desired position by means of cooperation between the tongues and the elongate channels.

The sandwich crimper is used to seal a tortilla folded in half and containing other food items. The removeable teeth when located in position within the slots serve to further divide the sandwich in two by means of crimping along the mid-point of the semi-circular sandwich resulting in two equally sized sandwiches facilitating the production of two discrete sandwiches that can contain the same or different ingredients.

The crimper is opened and a tortilla is positioned within the retaining walls. The edge of the circular tortilla is positioned above the bottom set of crimping teeth 14a. The sandwich contents are inserted on top of the tortilla, avoiding the edge.

The embodiments described above are provided by way of example only, and various changes and modifications will be apparent to persons skilled in the art without departing from the scope of the present invention as defined by the appended claims.

1. A sandwich crimper for producing a sealed pocket sandwich from a bread item comprising:
a housing having two clam shell members, hingedly connected to oner another and moveable between an open configuration and a closed configuration,
wherein the clam shell members are shaped to receive a bread item therebetween, and
wherein the clam shell members have peripheral crimping teeth capable of sealing the edge of the bread item when the clam shell is closed.

2. A crimper as claimed in claim 1 wherein the crimping teeth comprise protruding trapezoidal prisms.

3. A crimper as claimed in claim 2 wherein a first clam shell member comprises a top set of crimping teeth and a second clam shell member comprises a bottom set of crimping teeth, wherein the top and bottom sets of crimping teeth are complementarily shaped with respect to one another.

4. A crimper as claimed in claim 1 further comprising a peripheral retaining wall disposed along the outer edge of the crimper teeth for aligning the bread item relative to the crimping teeth and restraining the folded/pocket sandwich during the crimping process.

5. A sandwich crimper as claimed in claim 1, in which a protruding base wall is disposed along the bottom set of crimping teeth for containing a crimped sandwich's contents during the crimping process.

6. A sandwich crimper as claimed in claim 1, wherein the clam shell members are semi-circular in shape.

7. A sandwich crimper as claimed in claim 1, in which each crimping tooth is identical in size and shape.

8. A sandwich crimper as claimed in claim 1, further comprising an aperture disposed in the crimper base for facilitating the removal of a crimped sandwich.

9. A sandwich crimper as claimed in claim 1, further comprising dividing crimping teeth for crimping the body of the sandwich to divide the sandwich in two.

10. A sandwich crimper as claimed in claim 9 wherein the dividing crimping teeth are removeably mounted on the crimper.

11. A sandwich crimper as claimed in claim 9 wherein the dividing crimping teeth are received in a complementarily shaped slot disposed in each of the clam shell members.

12. A sandwich crimper as claimed in claim 9 wherein the dividing crimping teeth comprise a first and second set of dividing crimping teeth, each associated with the first and second clam shell member respectively.

13. A sandwich crimper as claimed in claim 11 wherein each clam shell member has a radially extending complementarily-shaped slot for receiving a set of dividing crimping teeth.

14. A sandwich crimper as claimed in claim 11 wherein the complementarily-shaped slots and the dividing crimping teeth comprise mating means comprising a male member and a female member such that the teeth and slots may mate to retain the teeth within the slot and the first and second claim shell members each receive one member of the dividing crimping teeth.

15. (canceled)

16. (canceled)

17. A sandwich crimper as claimed in claim 14 wherein each complementarily-shaped slot comprises one or more male members that are received in one or more female members disposed on the dividing teeth.

18. A sandwich crimper as claimed in claim 17 wherein each complementarily-shaped slot comprises one or more tongue and each of the first and second dividing teeth comprises one or more complementarily-shaped elongate groove to receive the more or more tongue.

19. A sandwich crimper as claimed in claim 18 wherein the first and second dividing teeth are each disposed on a linear track and wherein the dividing teeth divide the clam shell members into two equal halves.

20. (canceled)

21. A method of sealing a sandwich comprising the steps:
providing a sandwich crimper as claimed in any proceeding claim;
inserting a bread item onto the open clam shell members, positioned within the retaining wall;
inserting the sandwich contents onto the bread item;
closing the clam shell members and thereby folding the bread item; and
applying pressure to the clam shell members, engaging the top and bottom sets of crimping teeth and crimping at least the edges of the folded sandwich.

22. A method as claimed in claim 21, in which the sealing of the sandwich is followed by storing the sandwich within the closed crimper.

23. A method as claimed in claim 21 further comprising inserting dividing crimping teeth into each of the clam shell members.
